(19) United States
(12) Patent Application Publication
(10) Pub. No.: US 2006/0085812 A1
(43) Pub. Date: Apr. 20, 2006

(54) Method for monitoring television usage

(76) Inventors: Ahmad R. Shishegar, Woodland Hills, CA (US); Jonathan D. Gershan, Passaic, NJ (US); Michael Lazzaro, Chatham Township, NJ (US)

Correspondence Address: ROBROY R FAWCETT, 1576 KATELLA WAY, ESCONDIDO, CA, 92027, US

(21) Appl. No.: 10/966,826

(22) Filed: Oct. 15, 2004

(51) Int. Cl. H04H 9/00; H04N 7/16

(52) U.S. Cl. 725/19; 725/14; 725/9

(57) ABSTRACT

Disclosed is a method for monitoring usage of a programmable video recording device that records television program segments selected by on-screen graphics. In the method, an on-screen graphic associated with selecting a television program segment is intercepted. The selected television program segment is recognized using the intercepted on-screen graphic, and record usage information associated with the selected television program segment is generated. The record usage information may be included in a database for analysis. Other similar television usage may be monitored such as recorded program playback, game play, pay-per-view, and video-on-demand viewing.

### BACKGROUND OF THE INVENTION

1. Field of the Invention

The present invention relates to monitoring television usage, and more particularly, to methods for monitoring usage of a programmable video recording device, a video game, or requests for video-on-demand programming.

2. Description of the Prior Art and Related Information

Television audience information is used to rank programs and to set rates for advertising commercials. Current rating services have been criticized with respect to accuracy and effectiveness. Also, current rating services generally provide audience information in a format that ignores unscheduled or time-shifted television usage.

Accordingly, there exists a need for a system that may provide television usage information in a more effective and timely manner. The present invention satisfies these needs.

### SUMMARY OF THE INVENTION

The present invention may be embodied in a method for monitoring usage of a programmable video recording device that records a television program segment selected by at least one on-screen graphic. In the method, the on-screen graphic or graphics associated with selecting a television program segment are intercepted. The selected television program segment is recognized using the intercepted on-screen graphic, and record usage information associated with the selected television program segment is generated.

In more detailed features of the invention, the on-screen graphic may include a menu having a television program name field. Recognizing the selected television program segment using the intercepted on-screen graphic may include performing character recognition on the television program name field to determine the selected television program segment. Alternatively, the on-screen graphic may include a menu having a record start time field, a record stop time field or a record duration field, and a television channel number field. Character recognition may be performed on the record start time field, the record stop time field, the record duration field, and/or the television channel number field to determine the respective record start time, record stop time, the record duration, and the television channel. The record usage information associated with the selected television program segment may be included in a database for analysis.

In other more detailed features of the invention, the on-screen graphic associated with playback of a recorded television program segment may be intercepted. The playback of the recorded television program segment may be recognized using the intercepted on-screen graphic, and playback usage information associated with the recorded television program segment may be generated.

Alternatively, the present invention may be embodied in a method for monitoring usage of a programmable video recording device that plays back a recorded television program segment. In the method, on-screen graphic(s) associated with playback of a recorded television program segment are intercepted. The playback of the recorded television program segment is recognized using the intercepted on-screen graphic(s), and playback usage information associated with the recorded television program segment is generated.

The present invention also may be embodied in a method for monitoring requests for video-on-demand programming selected by at least one on-screen graphic. In the method, the on-screen graphic associated with selecting a video-on-demand television program is intercepted. The video-on-demand television program is recognized using the intercepted on-screen graphic, and video-on-demand request information associated with the selected video-on-demand television program is generated. The video-on-demand request information associated with the selected video-on-demand television program may be included in a database for analysis.

Similarly, the present invention also may be embodied in a method for monitoring requests for pay-per-view television programming selected by at least one on-screen graphic. In the method, the on-screen graphic associated with selecting a pay-per-view television program is intercepted. The pay-per-view television program is recognized using the intercepted on-screen graphic, and pay-per-view request information associated with the selected pay-per-view television program is generated. The pay-per-view request information associated with the selected pay-per-view television program may be included in a database for analysis.

Further, the present invention may be embodied in a method for monitoring usage of a video game. In the method, at least one on-screen graphic associated with play of a video game is intercepted. The video game is recognized using the intercepted on-screen graphic, and video game usage information is generated. The video game usage information may be included in a database for analysis.

### BRIEF DESCRIPTION OF THE DRAWINGS

The accompanying drawings illustrate embodiments of the present invention and, together with the description, serve to explain the principles of the invention.

FIG. 1 is a flow chart illustrating a method for monitoring usage of a programmable video recording device that records a television program segment selected by on-screen graphics, according to the present invention.

FIG. 2 is a block diagram of a television usage monitoring system, according to the present invention.

FIG. 3 is an exemplary on-screen graphic associated with selecting a television program segment, according to the present invention.

FIG. 4 is an exemplary on-screen graphic associated with selecting a television program segment by program name, according to the present invention.

FIG. 5 is an exemplary on-screen graphic associated with playback of a recorded television program segment, according to the present invention.

FIG. 6 is a flow chart illustrating a method for monitoring usage of a programmable video recording device that plays back a recorded television program segment, according to the present invention.

FIG. 7 is a flow chart illustrating a method for monitoring usage of a video game, according to the present invention.

FIG. 8 is an exemplary on-screen graphic associated with play of a video game, according to the present invention.

FIG. 9 is a flow chart illustrating a method for monitoring requests for video-on-demand television programming selected by on-screen graphics, according to the present invention.

FIG. 10 is an exemplary on-screen graphic of a main menu associated with selecting video-on-demand television programming.

FIG. 11 is an exemplary on-screen graphic of a first video-on-demand menu associated with selecting video-on-demand television programming.

FIG. 12 is an exemplary on-screen graphic of a second video-on-demand menu associated with selecting video-on-demand television programming.

FIG. 13 is an exemplary on-screen graphic of a confirmation screen associated with selecting a video-on-demand television program, according to the present invention.

FIG. 14 is a flow chart illustrating a method for monitoring requests for pay-per-view television programming selected by on-screen graphics, according to the present invention.

FIG. 15 is an exemplary on-screen graphic of a main menu associated with selecting pay-per-view television programming.

FIG. 16 is an exemplary on-screen graphic of a first pay-per-view menu associated with selecting pay-per-view television programming.

FIG. 17 is an exemplary on-screen graphic of a second pay-per-view menu associated with selecting pay-per-view television programming.

FIG. 18 is an exemplary on-screen graphic of a confirmation screen associated with selecting a pay-per-view television program, according to the present invention.

### DETAILED DESCRIPTION

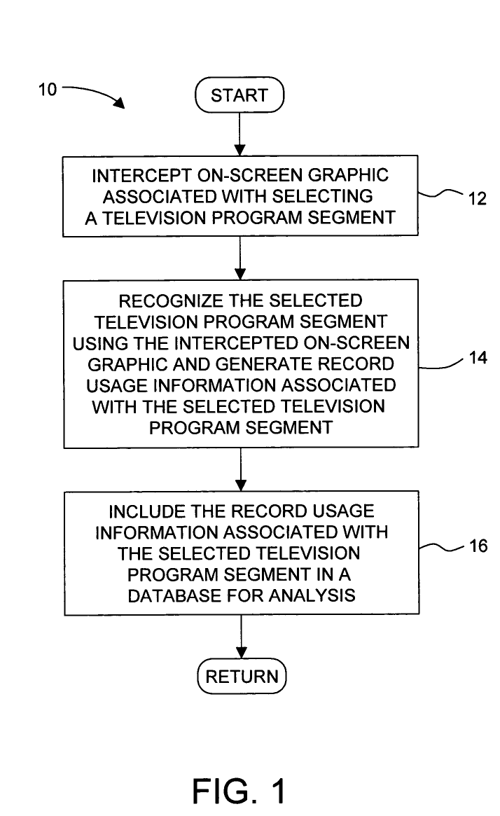

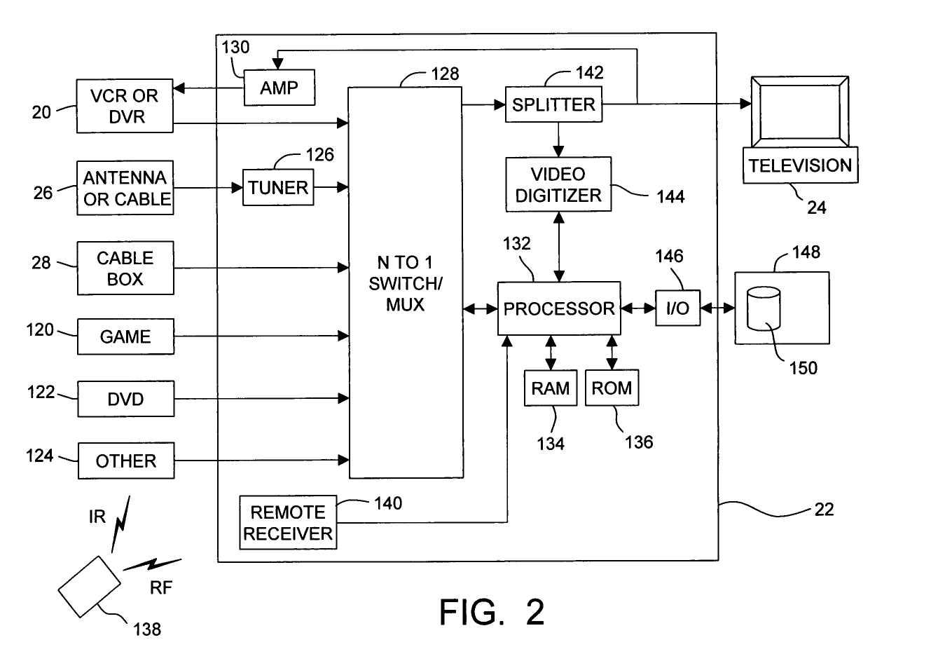

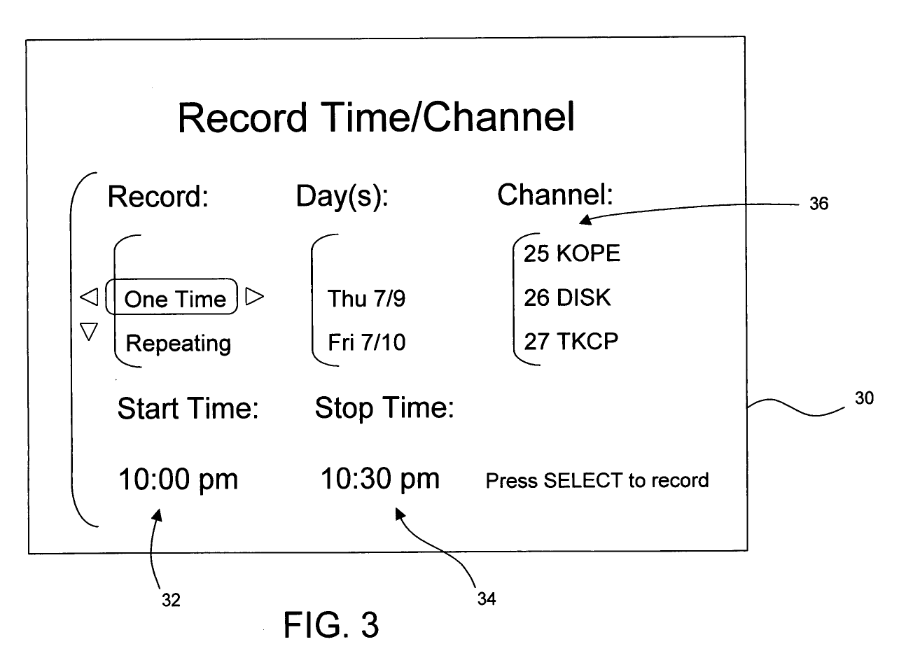

With reference to FIGS. 1-3, the present invention may be embodied in method 10 (FIG. 1) for monitoring usage of a programmable video recording device 20 (FIG. 2) that records a television program segment selected by at least one on-screen graphic 30 (FIG. 3). In the method, the on-screen graphic or graphics associated with selecting a television program segment are intercepted (step 12). The selected television program segment is recognized using the intercepted on-screen graphic, and record usage information associated with the selected television program segment is generated (step 14). The record usage information associated with the selected television program segment may be included in a database for analysis (step 16).

The on-screen graphic 30 may include a menu having a record start time field 32, a record stop time field 34 or a record duration field, and a television channel number field 36. The channel number field may be accompanied by the channel's call sign or similar alphanumeric characters. Other fields may include a record frequency field 38 or a day or date field 39. Character recognition may be performed on the record start time field, the record stop time field or the record duration field, and the television channel number field to determine the respective record start time, record stop time (or record duration), and the television channel. Character recognition may be performed on other fields, characters, or symbols in the on-screen graphics to assist in recognizing, or to supplement the record usage information.

The techniques of the present invention may be performed using an intelligent audio-visual (A/V) control device 22 (FIG. 2). The A/V control device is coupled between the output of the A/V equipment and an analog input of a television 24. Advantageously, the analog input of the television may be a composite video signal input and an audio signal input. The A/V equipment may include an antenna 26 (or cable if a cable set top box is not used) having a radio-frequency (rf) output. The A/V equipment also may include a programmable video recording device 20 such as a video cassette recorder (VCR) or a digital video recorder (DVR), a cable set top box 28 (or satellite dish box), a game console 120, a digital versatile disk (DVD) player 122, or other similar A/V device 124, each having a separate A/V output. The A/V control device may further include a tuner 126 for converting the rf signal at the rf output of the antenna (or cable) to a component video signal and an audio signal. The cable set top box may have an rf output coupled to an rf input of the video recording device 20. Each respective A/V signal of the A/V equipment and the tuner is coupled to a separate A/V input of an A/V switch 128 or multiplexer (MUX). The A/V switch has a number N of A/V inputs, where N is the allowable number of separate pieces of A/V equipment. The A/V equipment may be integrated and may share an integrated A/V output, e.g., a DVR may be integrated with a cable set top box or a satellite dish box, etc.

The A/V switch 128 is controlled by a processor 132. The processor is coupled to memory devices, such as volatile random access memory (RAM) 134 or nonvolatile memory 136 that may comprise flash memory or read-only memory (ROM). Program code for implementing the techniques of the invention may be stored in the ROM 136 and transferred to the RAM 134 for execution by the processor. The memory devices also provide storage of the information generated by the A/V control device 22 during the implementation of the techniques of the invention. A remote control device 138 is used for selecting the desired A/V equipment and television programming. The remote control device has an infrared (IR) channel for controlling the A/V equipment and a radio frequency (rf) channel for communicating the A/V control signals to the A/V control device 22 through a remote rf receiver 140. The A/V control signals are accessed by the processor for determining which A/V input of the A/V switch 128 should be selected for output to the television 24. The output of the A/V switch is coupled to the television through a signal splitter 142. The output of the A/V also may be coupled to an A/V amplifier 130 for connection to an A/V input of the video recording device 20. A video digitizer 144 is coupled to the splitter for intercepting the analog video portion of the A/V signal viewed on the television, and converting the analog video signal to a digital video signal. The processor may capture each video frame from the video digitizer, or it may capture a sample of the video frames, such as each fifth video frame.

The video recording device 20 generates at least one on-screen graphic 30 for allowing selection of the desired television program segment. The on-screen graphics may include additional on-screen graphics originally generated by the cable set top box 28 (and/or satellite dish box) coupled to the rf input of the video recording device. The on-screen graphic is intercepted by the A/V control device 22 and converted to a corresponding digital video frame. The text in the digital video frame may be recognized using video or electronic character recognition (ECR). Suitable software for performing ECR on video text characters may be available from SRI International of Menlo Park, Calif. The ECR software generates an ASCII text output based on the video alphanumeric text characters in the on-screen graphic. The ECR software also generates a confidence value which indicates to the processor that the ASCII text output contains valid data.

The AV control device 22 also includes input/output (I/O) channels 146 for communicating the usage information to a central server 148. The central server may have a database 150 for storing the usage information for analysis. The I/O channels may include a serial or Universal Serial Bus (USB) interface, an Ethernet interface, a wireless modem connection, or the like. Techniques and systems for including the usage information in a database of a central server are disclosed in U.S. patent application Ser. No. 10/890,399, titled TELEVISION AUDIENCE REPORTING SYSTEM AND METHOD, which application is incorporated herein by reference.

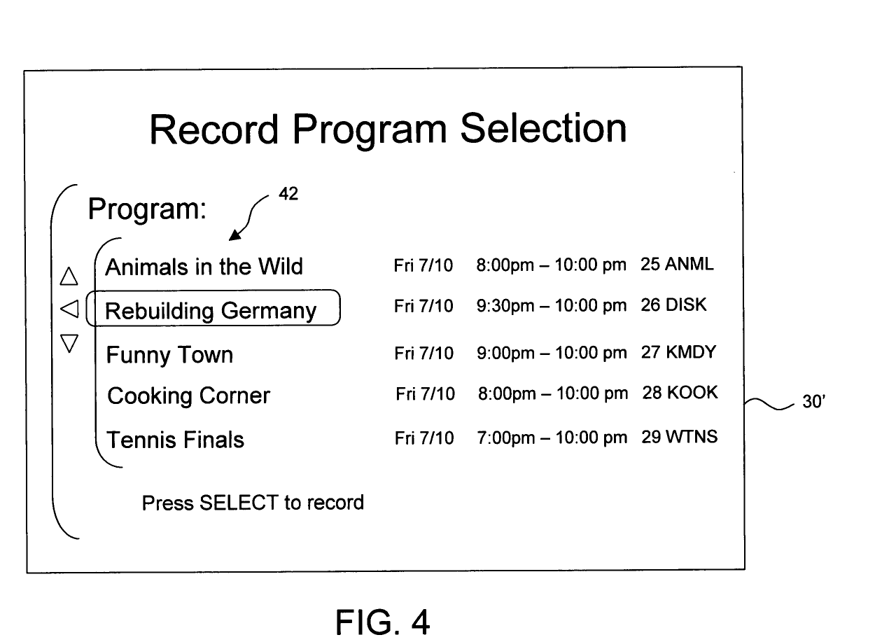

With reference to FIG. 4, the on-screen graphic 30′ may include a menu having a television program name field 42. Recognizing the selected television program segment using the intercepted on-screen graphic may include performing character recognition on the television program name field to determine the selected television program segment.

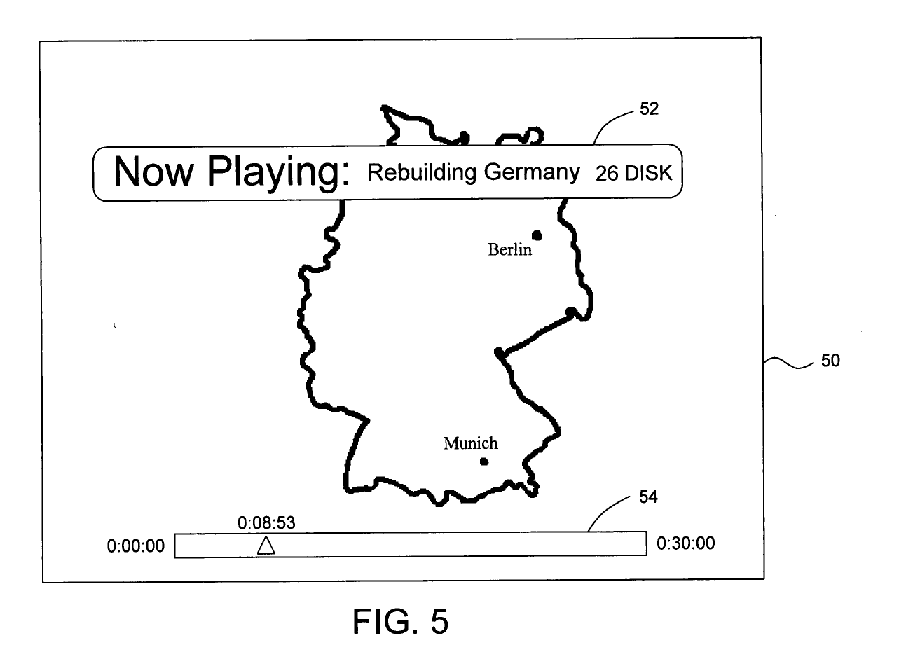

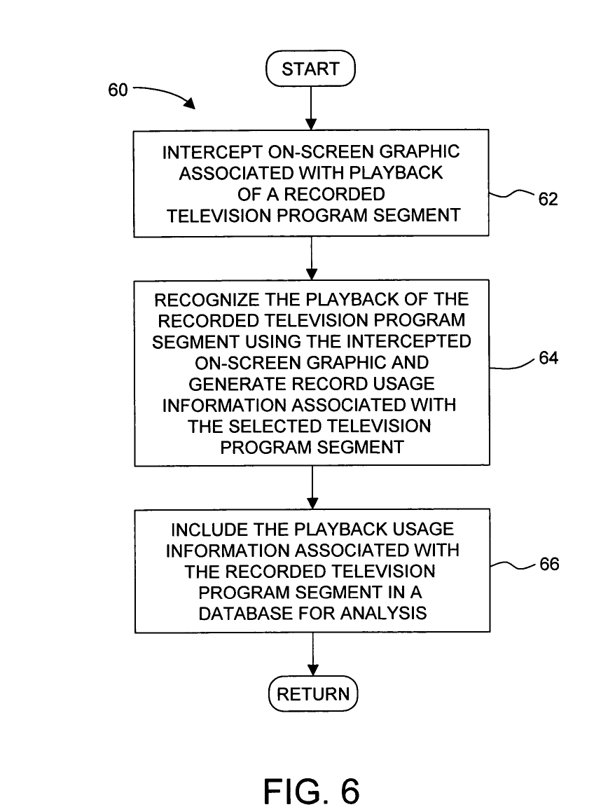

With reference to FIGS. 5 and 6, the present invention also or additionally may be embodied in a method 60 for monitoring usage of a programmable video recording device 20 that plays back a recorded television program segment. In the method, on-screen graphic(s) 50 associated with playback of a recorded television program segment are intercepted (step 62). The playback of the recorded television program segment is recognized using the intercepted on-screen graphic(s), and playback usage information associated with the recorded television program segment is generated (step 64). The on-screen graphic may comprise a pop-up box 52 having identifying information such as the program name, channel number, etc. The video recording may also generate a pop-up or overlaid progress bar 54 that allows tracking of the playback of the recorded television segment. The playback usage information may be included in a database 150 for analysis (step 66)

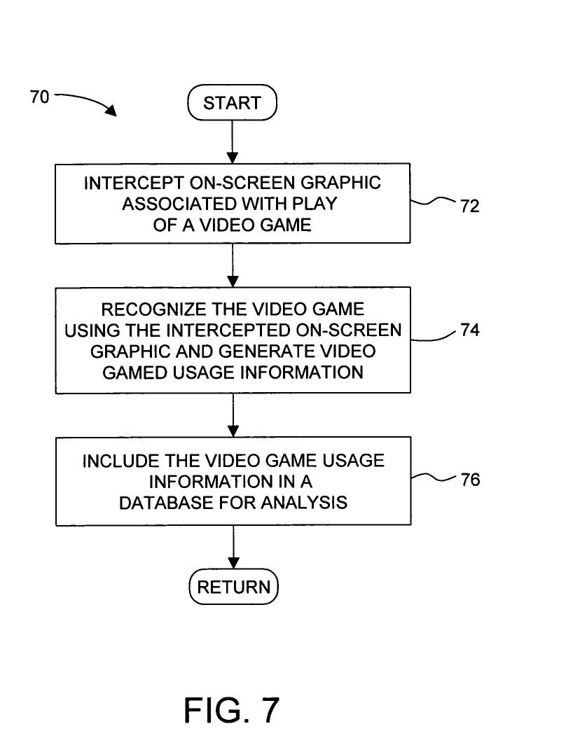

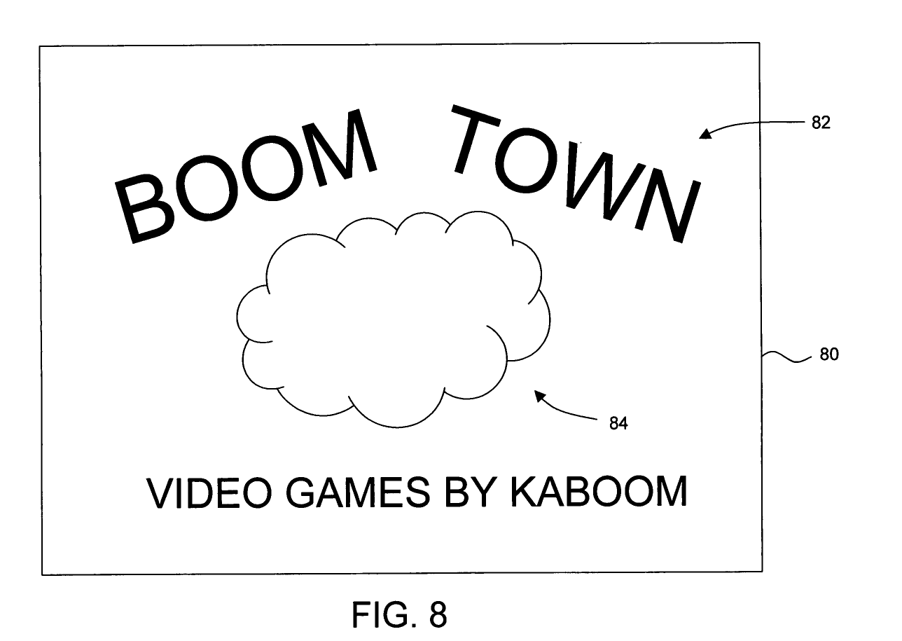

With reference to FIGS. 7 and 8, the present invention may be embodied in a method 70 for monitoring usage of a video game 120. In the method, at least one on-screen graphic 80 associated with play of a video game is intercepted (step 72). The video game is recognized using the intercepted on-screen graphic, and video game usage information is generated (step 74. The video game may be recognized using a text field 82 having the game's name, or using a symbol 84 that is uniquely associated with the game. The video game usage information likewise may be included in a database 150 for analysis.

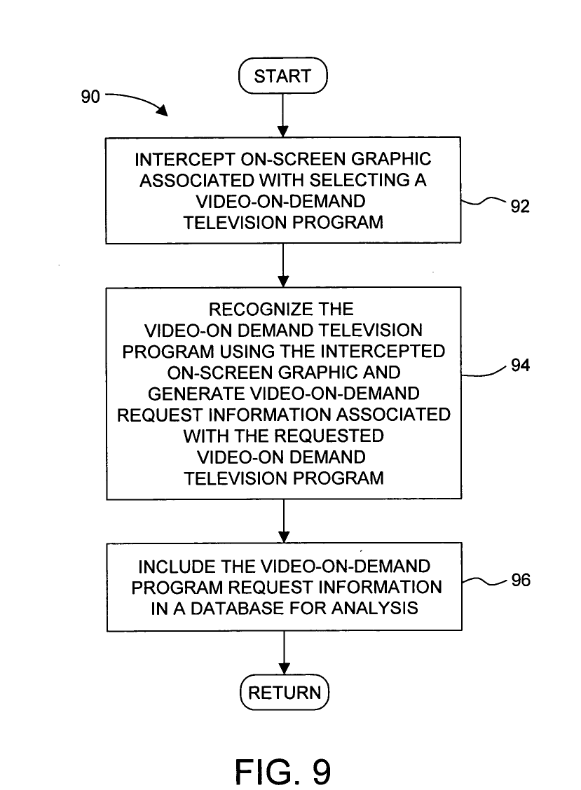

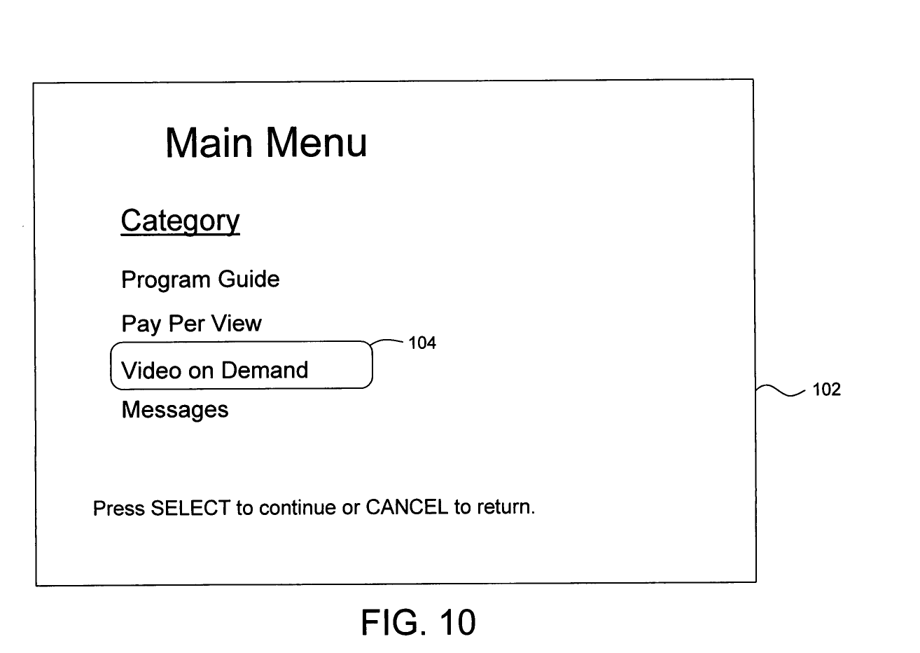

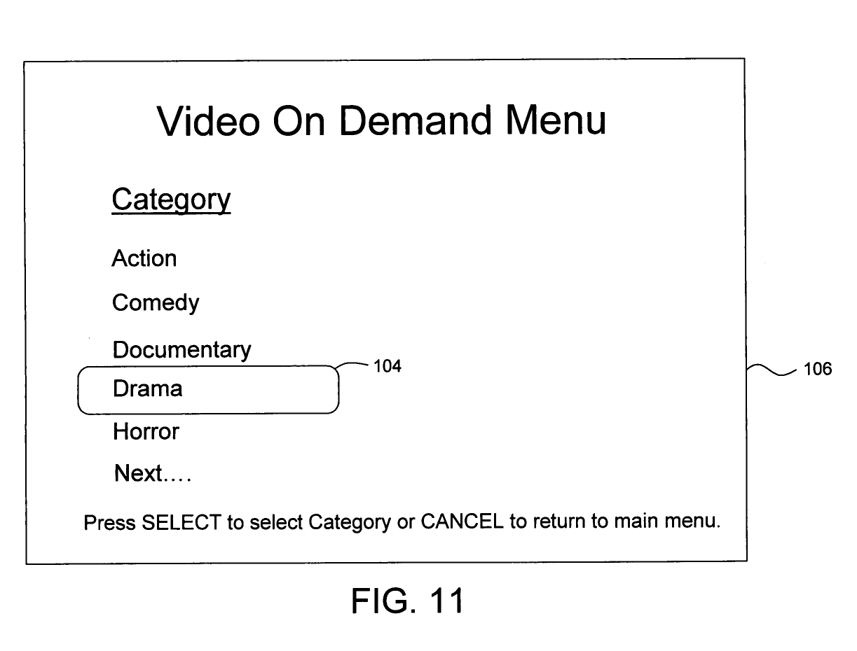

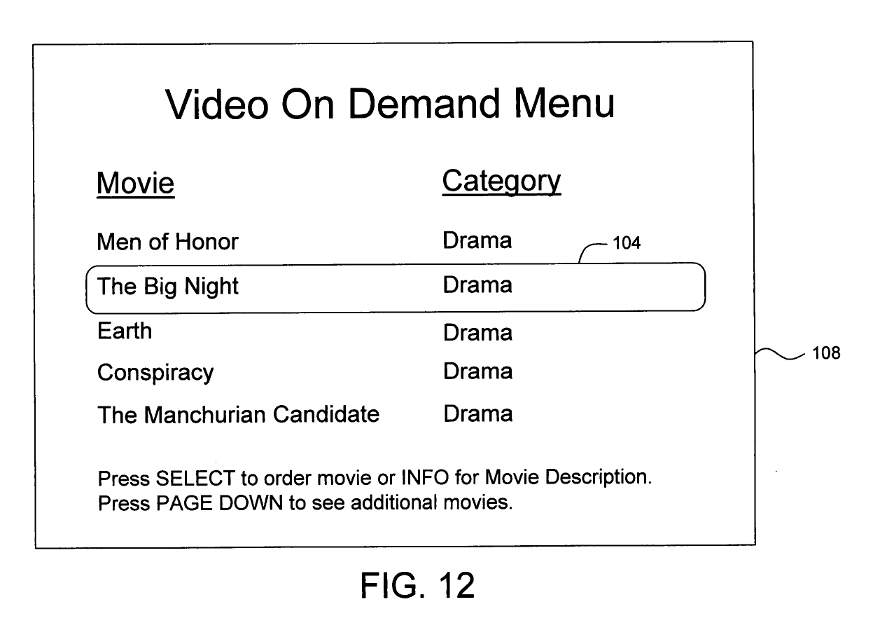

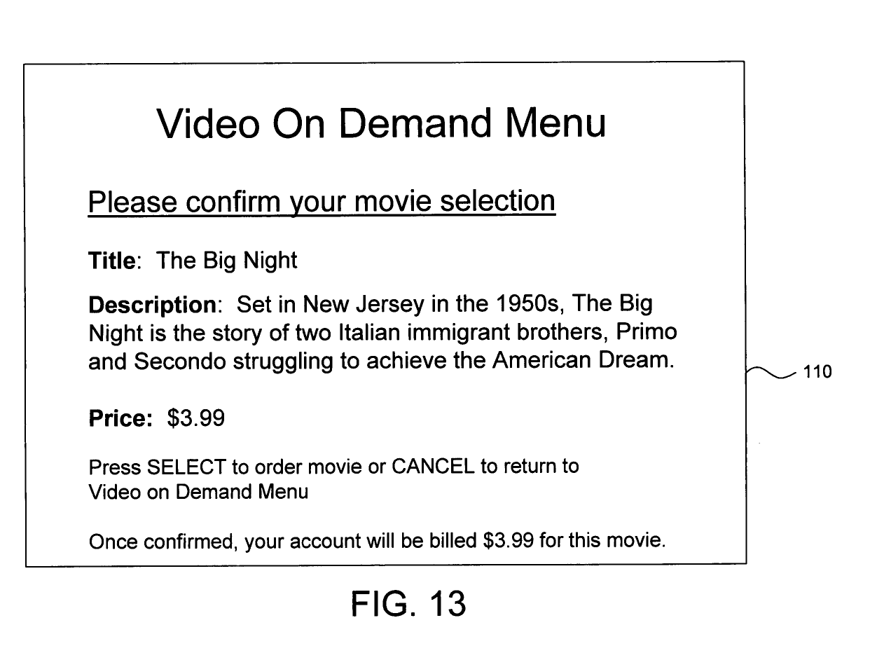

With reference to FIGS. 9-13, the present invention similarly may be embodied in a method 90 for monitoring requests for video-on-demand television programming selected by at least one on-screen graphic 110. In the method, the on-screen graphic associated with selecting a video-on-demand television program is intercepted (step 92). The video-on-demand television program is recognized using the intercepted on-screen graphic, and video-on-demand request information associated with the selected video-on-demand television program is generated (step 94). The video-on-demand request information associated with the selected video-on-demand television program may be included in a database 150 for analysis (step 96).

Video-on-demand television programming, often provided by a cable television provider, allows a viewer to watch a selected television program, such as a movie, an unscheduled time of the viewer's choice and convenience. An initial on-screen graphic may present a main menu 102 with category selections such as Program Guide, Pay Per View, Video on Demand, and Messages. The remote control device 138 is used to scroll to the desired selection. A highlighted focus box 104 indicates the selection under consideration. The highlighted item is selected using a SELECT button on the remote control device. When the Video on Demand item is selected, a next on-screen graphic may have a Video on Demand menu 106 that provides movie category selections such as action, comedy, documentary, drama, horror, and a next selection for viewing additional categories. After selecting a category such as drama, a next on-screen graphic may present another Video on Demand menu 108 that presents selectable television programs in the drama movie category. The viewer can press an INFO button on the remove control device to see a description of the highlighted movie. Once a movie is selected, an on-screen graphic may present a confirmation screen 110 that allows the viewer to review and confirm the selection. The confirmation and/or subsequent on-screen graphics relating to the selection of the video-on-demand television program may be used for recognizing the selected video-on-demand television program.

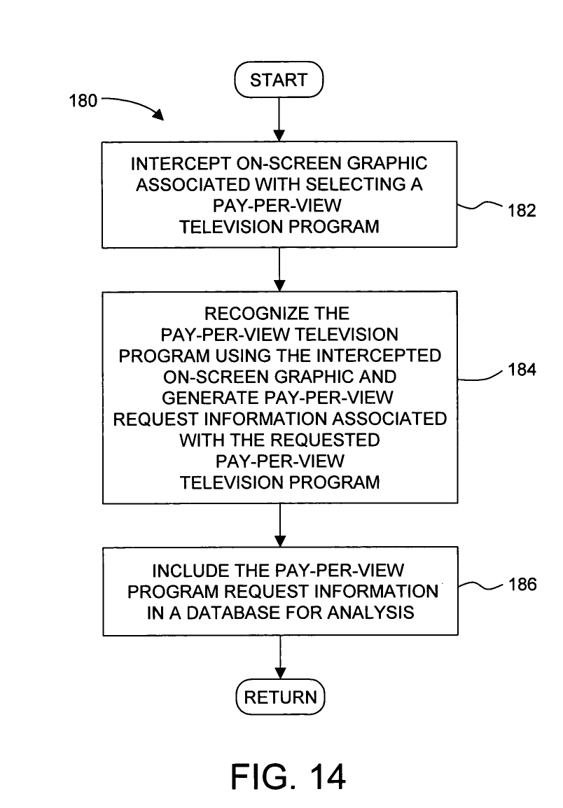

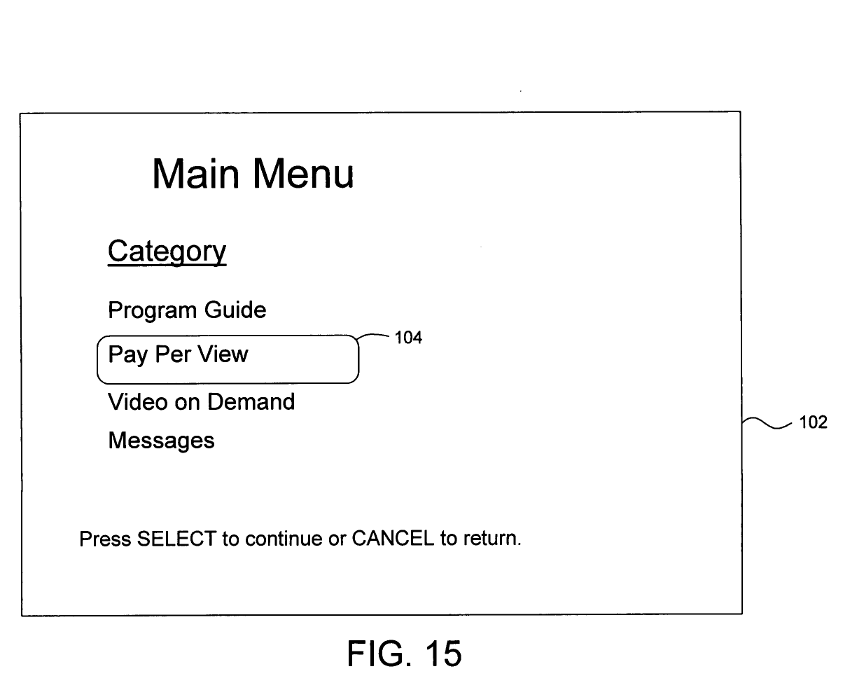

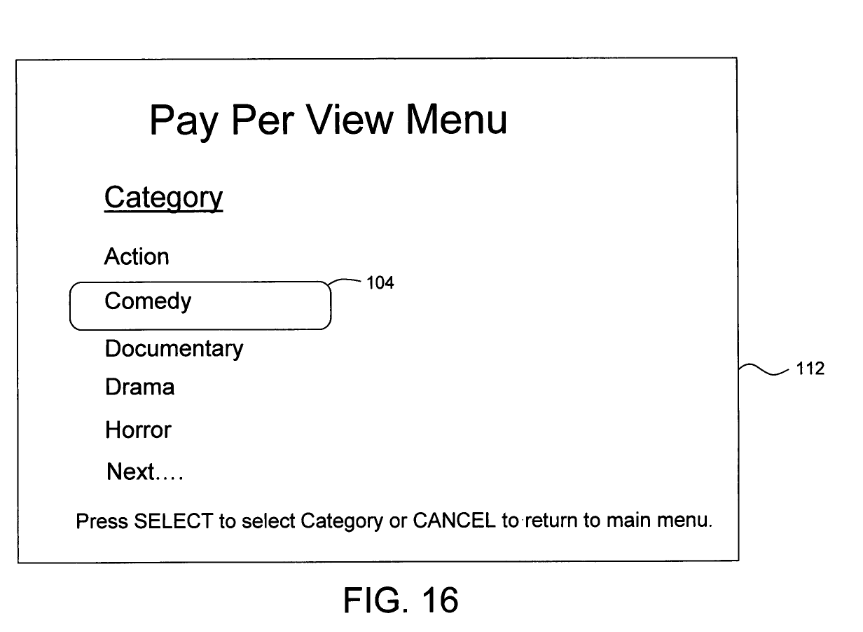

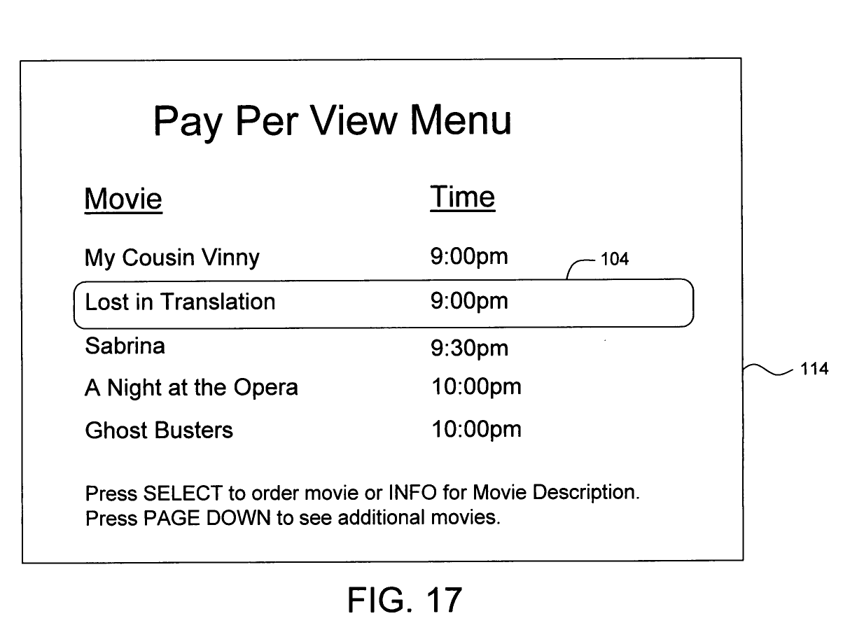

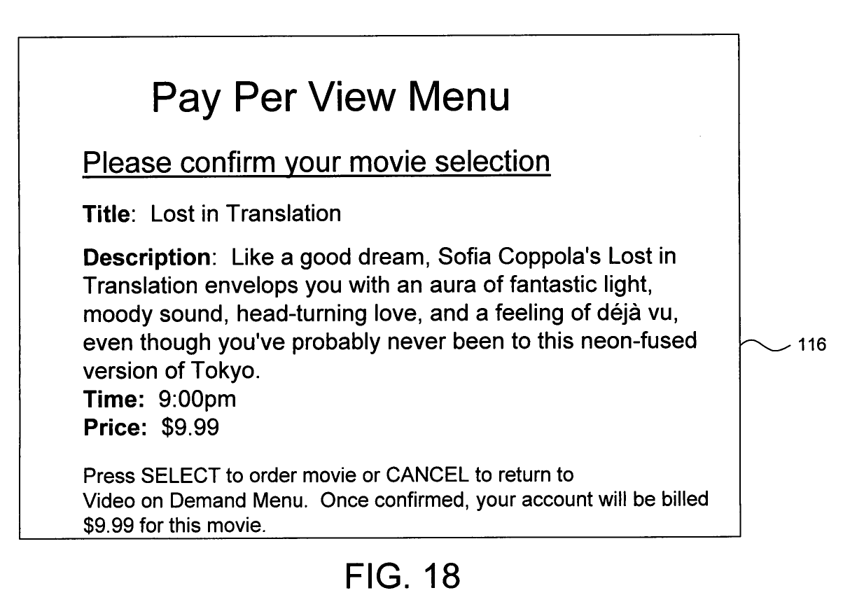

With reference to FIGS. 14-18, the present invention similarly may be embodied in a method 180 for monitoring requests for pay-per-view television programming selected by at least one on-screen graphic 116. In the method, the on-screen graphic associated with selecting a pay-per-view television program is intercepted (step 182). The pay-per-view television program is recognized using the intercepted on-screen graphic, and pay-per-view request information associated with the selected pay-per-view television program is generated (step 184). The pay-per-view request information associated with the selected pay-per-view television program may be included in a database 150 for analysis (step 186).

Pay-per-view television programming, often provided by a cable television provider or a satellite dish television provider, allows a viewer to watch a selected television program at a pre-scheduled time set by the program provider. When the Pay Per View item is selected on the main menu 102, a next on-screen graphic may have a Pay Per View menu 112 that provides television program category selections such as action, comedy, documentary, drama, horror, and a next selection for viewing additional categories. After selecting a category such as comedy, a next on-screen graphic may present another Pay Per View menu 114 that presents selectable television programs in the comedy category. The viewer can press an INFO button on the remove control device to see a description of the highlighted movie. Once a movie is selected, an on-screen graphic may present a confirmation screen 116 that allows the viewer to review and confirm the selection. The confirmation and/or subsequent on-screen graphics relating to the selection of the pay-per-view television program may be used for recognizing the selected pay-per-view television program.

What is claimed is:

1. A method for monitoring usage of a programmable video recording device that records a television program segment selected by at least one on-screen graphic, comprising:
intercepting the on-screen graphic(s) associated with selecting a television program segment; and
recognizing the selected television program segment using the intercepted on-screen graphic(s) and generating record usage information associated with the selected television program segment.

2. A method for monitoring usage of a programmable video recording device as defined in claim 1, wherein the at least one on-screen graphic includes a menu having a television program name field.

3. A method for monitoring usage of a programmable video recording device as defined in claim 2, wherein recognizing the selected television program segment using the intercepted on-screen graphic(s) comprises performing character recognition on the television program name field to determine the selected television program segment.

4. A method for monitoring usage of a programmable video recording device as defined in claim 1, wherein the at least one on-screen graphic includes a menu having a record start time field, a record stop time field, and a television channel number field.

5. A method for monitoring usage of a programmable video recording device as defined in claim 4, wherein recognizing the selected television program segment using the intercepted on-screen graphic(s) comprises performing character recognition on the record start time field, the record stop time field, and the television channel number field to determine the record start time, record stop time, and the television channel.

6. A method for monitoring usage of a programmable video recording device as defined in claim 1, wherein the at least one on-screen graphic includes a menu having a record start time field, a record duration field, and a television channel number field.

7. A method for monitoring usage of a programmable video recording device as defined in claim 6, wherein recognizing the selected television program segment using the intercepted on-screen graphic(s) comprises performing character recognition on the record start time field, the record duration field, and the television channel number field to determine the record start time, record duration, and the television channel.

8. A method for monitoring usage of a programmable video recording device as defined in claim 1, further comprising including the record usage information associated with the selected television program segment in a database for analysis.

9. A method for monitoring usage of a programmable video recording device as defined in claim 1, further comprising:
intercepting the on-screen graphic(s) associated with playback of a recorded television program segment;
recognizing the playback of the recorded television program segment using the intercepted on-screen graphic(s) and generating playback usage information associated with the recorded television program segment.

10. A method for monitoring usage of a programmable video recording device that plays back a recorded television program segment, comprising:
intercepting on-screen graphic(s) associated with playback of a recorded television program segment;
recognizing the playback of the recorded television program segment using the intercepted on-screen graphic(s) and generating playback usage information associated with the recorded television program segment.

11. A method for monitoring usage of a programmable video recording device as defined in claim 10, further comprising including the playback usage information associated with the recorded television program segment in a database for analysis.

12. A method for monitoring requests for video-on-demand programming selected by at least one on-screen graphic, comprising:
intercepting the on-screen graphic(s) associated with selecting a video-on-demand television program; and
recognizing the video-on-demand television program using the intercepted on-screen graphic(s) and generating video-on-demand request information associated with the selected video-on-demand television program.

13. A method for monitoring requests for video-on-demand programming as defined in claim 12, further comprising including the video-on-demand request information in a database for analysis.

14. A method for monitoring requests for pay-per-view programming selected by at least one on-screen graphic, comprising:
intercepting the on-screen graphic(s) associated with selecting a pay-per-view television program; and
recognizing the pay-per-view television program using the intercepted on-screen graphic(s) and generating pay-per-view request information associated with the selected pay-per-view television program.

15. A method for monitoring requests for pay-per-view programming as defined in claim 14, further comprising including the pay-per-view request information in a database for analysis.

16. A method for monitoring usage of a video game, comprising:
intercepting at least one on-screen graphic associated with play of a video game; and
recognizing the video game using the intercepted on-screen graphic(s) and generating video game usage information.

17. A method for monitoring usage of a video game as defined in claim 16, further comprising including the video game usage information in a database for analysis.
